(19) United States
(12) Patent Application Publication
(10) Pub. No.: US 2024/0402957 A1
(43) Pub. Date: Dec. 5, 2024

(54) COMPUTER-READABLE STORAGE MEDIUM, PRINTING SYSTEM, AND METHOD FOR CONFIGURING PRINT SETTINGS BASED ON COMMON CAPABILITIES OF PRINTERS CONNECTABLE WITH SERVER

(71) Applicant: BROTHER KOGYO KABUSHIKI KAISHA, Nagoya (JP)

(72) Inventor: Yoshito HOSOMIZO, Konan (JP)

(21) Appl. No.: 18/802,215

(22) Filed: Aug. 13, 2024

Related U.S. Application Data
(63) Continuation of application No. PCT/JP2023/009280, filed on Mar. 10, 2023.

(30) Foreign Application Priority Data
Mar. 23, 2022 (JP) 2022-047229

(51) Int. Cl. G06F 3/12

(52) U.S. Cl. CPC G06F 3/1232; G06F 3/1205

(57) ABSTRACT

A computer-readable storage medium stores computer-readable instructions supporting a general-purpose print program incorporated in an operating system of an information processing device. The instructions, when executed by a computer of the information processing device, cause the information processing device to obtain specific information to identify a selected printing device, obtain capability information indicating capabilities of the selected printing device, determine, in response to receiving a processing request from the general-purpose print program, whether the selected printing device is a virtual printer of a server on a network, based on the specific information, display a first print setting screen configured to accept print settings based on the capability information when the selected printing device is not the virtual printer, and display a second print setting screen configured to accept print settings based on common capabilities of printing devices connectable with the server when the selected printing device is the virtual printer.

### REFERENCE TO RELATED APPLICATIONS

This application is a continuation of PCT International Application No. PCT/JP2023/009280 filed on Mar. 10, 2023, and claims priority from Japanese Patent Application No. 2022-047229 filed on Mar. 23, 2022, which are incorporated herein by reference in their entirety.

### BACKGROUND ART

In recent years, a technology has been put to practical use in which a printer is controlled by a general-purpose print program that is incorporated as standard into an operating system (hereinafter referred to as the “OS”) of an information processing device, without using a printer driver. In this technology, the OS associates the printer with the OS-standard general-purpose print program in response to detecting the printer, and thereafter, the information processing device is enabled to cause the printer to perform printing with the OS-standard general-purpose print program without using a printer driver in response to receiving a print instruction to the printer.

In addition, technologies related to a so-called cloud printing system have been known, in which a cloud server on the Internet is used as a virtual printer, a print job is input into the virtual printer from the OS-standard general-purpose print program, and a printer connected with the cloud server receives the print job and performs printing. For instance, as one of the technologies related to the cloud printing system, a configuration has been disclosed in which an extended cloud printing service is provided separately from a general-purpose cloud printing service, thereby handling settings based on printer-specific functions.

### SUMMARY

There is a problem that the OS-standard general-purpose print program supports only standard print settings and does not support settings based on the printer-specific functions. Therefore, it is difficult to handle the settings based on the printer-specific functions even when printing is performed from the general-purpose print program via the cloud printing system. When the settings based on the printer-specific functions are handled by a separately-prepared extended cloud printing service as disclosed, facilities required for the extended cloud printing service are likely to be large in scale, which may easily lead to higher costs.

According to aspects of the present disclosure, a non-transitory computer-readable storage medium is provided, which stores computer-readable instructions that are executable by a computer of an information processing device. The instructions support a general-purpose print program incorporated in advance in an operating system of the information processing device. The instructions are configured to, when executed by the computer, cause the information processing device to obtain specific information to identify a selected printing device. The instructions are further configured to, when executed by the computer, cause the information processing device to obtain capability information indicating capabilities of the selected printing device. The instructions are further configured to, when executed by the computer, cause the information processing device to determine, in response to receiving a processing request from the general-purpose print program, whether the selected printing device is a virtual printer based on the obtained specific information. The virtual printer is provided on a server on a network and connectable with the information processing device. The server is configured to receive and store a print job sent to the virtual printer. The server is further configured to send the stored print job to a printing device connected with the server in response to a request from the printing device. The instructions are further configured to, when executed by the computer, cause the information processing device to perform a display process to display, on a display of the information processing device, different print setting screens depending on whether the selected printing device is the virtual printer. The display process includes a first display process to display a first print setting screen on the display in response to determining that the selected printing device is not the virtual printer. The first print setting screen is configured to accept print settings based on the obtained capability information. The display process further includes a second display process to display a second print setting screen on the display in response to determining that the selected printing device is the virtual printer. The second print setting screen is configured to accept print settings based on common capabilities of printing devices connectable with the server.

According to aspects of the present disclosure, further provided is a printing system that includes a server on a network, a printing device connected with the server, and an information processing device. The server has a virtual printer. The information processing device is configured to connect with the virtual printer provided on the server on the network. The information processing device includes a computer, and a non-transitory computer-readable storage medium storing computer-readable instructions supporting a general-purpose print program incorporated in advance in an operating system of the information processing device. The computer-readable instructions are configured to, when executed by the computer, cause the information processing device to, in response to receiving a request for processing from the general-purpose print program when a print instruction to cause the virtual printer to print a target image has been output from an application program incorporated in the information processing device to the general-purpose print program, obtain image data representing the target image from the general-purpose print program, and send a print job with the obtained image data to the virtual printer. The server is configured to receive and store the print job sent to the virtual printer. The printing device is configured to send a transmission request to the server to send the print job stored in the server. The printing device is further configured to receive the print job sent by the server in response to the transmission request. The printing device is further configured to perform printing based on the received print job. The computer-readable instructions are further configured to, when executed by the computer, cause the information processing device to obtain specific information to identify a selected printing device. The computer-readable instructions are further configured to, when executed by the computer, cause the information processing device to obtain capability information indicating capabilities of the selected printing device. The computer-readable instructions are further configured to, when executed by the computer, cause the information processing device to determine, in response to receiving a processing request from the general-purpose print program, whether the selected printing device is a virtual printer based on the obtained specific information. The computer-readable instructions are further configured to, when executed by the computer, cause the information processing device to perform a display process to display, on a display of the information processing device, different print setting screens depending on whether the selected printing device is the virtual printer. The display process includes a first display process to display a first print setting screen on the display in response to determining that the selected printing device is not the virtual printer. The first print setting screen is configured to accept print settings based on the obtained capability information. The display process further includes a second display process to display a second print setting screen on the display in response to determining that the selected printing device is the virtual printer. The second print setting screen is configured to accept print settings based on common capabilities of printing devices connectable with the server.

According to aspects of the present disclosure, further provided is a method implementable by a computer executing computer-readable instructions on an information processing device. The instructions support a general-purpose print program incorporated in advance in an operating system of the information processing device. The method includes obtaining specific information to identify a selected printing device. The method further includes obtaining capability information indicating capabilities of the selected printing device. The method further includes determining, in response to receiving a processing request from the general-purpose print program, whether the selected printing device is a virtual printer based on the obtained specific information. The virtual printer is provided on a server on a network and connectable with the information processing device. The server is configured to receive and store a print job sent to the virtual printer. The server is further configured to send the stored print job to a printing device connected with the server in response to a request from the printing device. The method further includes performing a display process to display, on a display of the information processing device, different print setting screens depending on whether the selected printing device is the virtual printer. The display process includes a first display process to display a first print setting screen on the display in response to determining that the selected printing device is not the virtual printer. The first print setting screen is configured to accept print settings based on the obtained capability information. The display process further includes a second display process to display a second print setting screen on the display in response to determining that the selected printing device is the virtual printer. The second print setting screen is configured to accept print settings based on common capabilities of printing devices connectable with the server.

### BRIEF DESCRIPTION OF DRAWINGS

FIG. 1 is a block diagram schematically showing a configuration of a printing system.

FIG. 2A is a flowchart showing a procedure of an initial value setting process.

FIG. 2B shows an example of setting data.

FIG. 3 shows an example of an initial value setting screen.

FIG. 4 is a sequence diagram showing an example of a procedure when “Print” is selected.

FIG. 5 shows an example of a general-purpose print setting screen.

FIG. 6 shows an example of the general-purpose print setting screen (which may be an example of a “first print setting screen” according to aspects of the present disclosure) when a virtual printer is not selected.

FIG. 7 shows an example of the general-purpose print setting screen (which may be an example of a “second print setting screen” according to aspects of the present disclosure) when the virtual printer is selected.

FIG. 8 is a sequence diagram showing an example of a procedure when a print instruction has been received.

FIG. 9 is a sequence diagram showing an example of a procedure when “Print” is selected.

FIG. 10 is a sequence diagram showing an example of a procedure when “Detailed Settings” is selected.

FIG. 11 shows an example of a detailed setting screen when the virtual printer is not selected.

FIG. 12 shows an example of the detailed setting screen when the virtual printer is selected.

### DESCRIPTION

It is noted that various connections are set forth between elements in the following description. It is noted that these connections in general and, unless specified otherwise, may be direct or indirect and that this specification is not intended to be limiting in this respect. Aspects of the present disclosure may be implemented on circuits (such as application specific integrated circuits) or in computer software as programs storable on computer-readable media including but not limited to RAMs, ROMs, flash memories, EEPROMs, CD-media, DVD-media, temporary storage, hard disk drives, floppy drives, permanent storage, and the like.

In the present disclosure, an inclusive OR, meaning that it includes either A or B or both, may be expressed as “A and/or B,” “at least one of A or B,” or “at least one selected from the group consisting of A and B.”

A detailed explanation will be provided below of a personal computer (hereinafter referred to as the “PC”) using a support program according to aspects of the present disclosure, with reference to the accompanying drawings. In the present disclosure, a printing system configured to cause a printer to perform printing from an OS-standard general-purpose print program via a cloud printing system is described.

### First Illustrative Embodiment

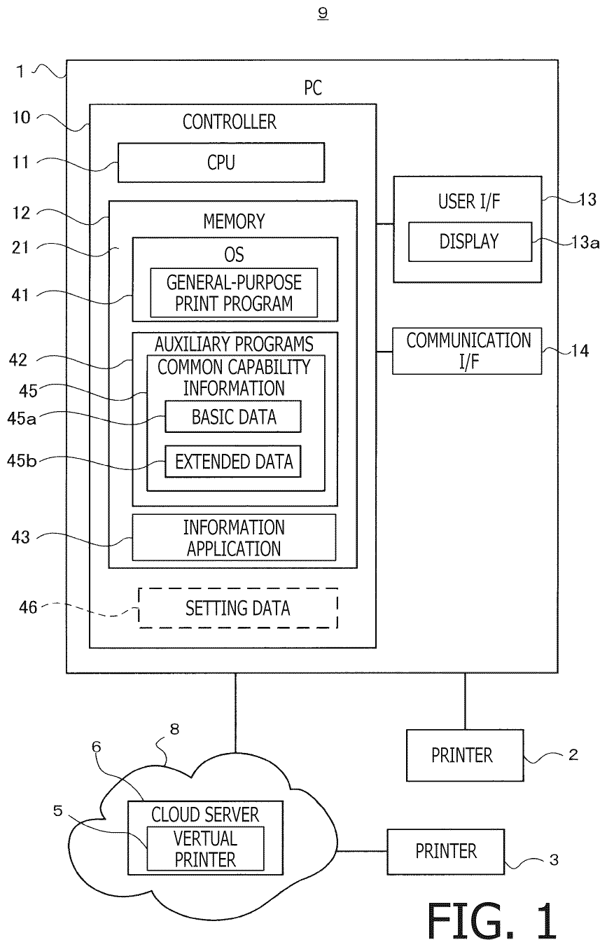

FIG. 1 schematically shows a configuration of a printing system 9. The printing system 9 includes a PC1, a printer 2, and a printer 3. The printer 2 may be connected with the Internet 8 or directly connected with the PC 1. The PC 1 and the printer 3 are communicably interconnected with a cloud server 6 on the Internet 8. The cloud server 6 has a virtual printer 5. The printer 2 and the printer 3 are real physical printers. Meanwhile, the virtual printer 5 is a logical printer that is virtually treated as a single printer. Hereinafter, for the sake of explanatory convenience, the real physical printers may be referred to as the “real printers.”

For instance, the printing system 9 is a system that uses cloud services provided by Microsoft Corporation to achieve universal printing in which printing is performed via the virtual printer 5. Namely, the cloud server 6 may be provided by a company other than printer manufacturers. The Internet 8 may be an example of a “network” according to aspects of the present disclosure. The cloud server 6 may be an example of a “server” according to aspects of the present disclosure.

As shown in FIG. 1, a PC 1 of the illustrative embodiment has a controller 10 that includes a CPU 11 and a memory 12. The PC 1 may be an example of an “information processing device” according to aspects of the present disclosure. The CPU 11 may be an example of a “computer” according to aspects of the present disclosure. The PC 1 further includes a user interface (hereinafter referred to as the “user I/F”) 13 and a communication interface (hereinafter referred to as the “communication I/F”) 14, which are electrically connected with the controller 10. The “controller 10” in FIG. 1 is a collective term for hardware and software used to control the PC 1, and may not necessarily represent a single hardware element actually existing in the PC 1.

The CPU 11 is configured to perform various processes according to programs read from the memory 12 and based on user operations. The memory 12 stores various types of data and various programs. The memory 12 is also used as a work area when various processes are performed. A buffer provided to the CPU 11 may be an example of a “memory” according to aspects of the present disclosure. Examples of the memory 12 are not limited to a ROM, a RAM, and an HDD that are incorporated in the PC 1, but may include storage media (e.g., CD-ROMs and DVD-ROMs) that are readable and writable by the CPU 11.

The user I/F 13 includes hardware configured to display screens to provide information to the user, and hardware configured to receive user operations. The user I/F 13 may have a combination of a display 13a configured to display information, and a mouse and/or a keyboard that are configured to accept user input operations, i.e., having an input acceptance function. The user I/F 13 may include a touch panel having the display 13a and the input acceptance function. The user I/F 13 includes an example of a “display” according to aspects of the present disclosure.

The communication I/F 14 includes hardware configured to communicate with external devices such as a printer 2. Communication standards applicable for the communication I/F 14 include Ethernet (“Ethernet” is a registered trademark of Fuji Xerox Co., Ltd.), Wi-Fi (“Wi-Fi” is a registered trademark of the non-profit Wi-Fi Alliance), and USB. The PC 1 may be configured to connect with the Internet via the communication I/F 14. The PC 1 may have a plurality of communication I/Fs 14 conforming to a plurality of communication standards.

As shown in FIG. 1, the memory 12 of the PC 1 stores an operating system (hereinafter referred to as the “OS”) 21 including a general-purpose print program 41, and further stores auxiliary programs 42 and various application programs (hereinafter, which may be referred to as the “applications”). Examples of the OS 21 may include, but are not limited to, Windows (“Windows” is a registered trademark of Microsoft Corporation), macOS (“macOS” is a registered trademark of Apple Inc.), Linux (“Linux” is a registered trademark of Linus Torvalds), iOS (“iOS” is a registered trademark of Cisco Systems, Inc.), and Android (“Android” is a registered trademark of Google LLC).

The PC 1 in the illustrative embodiment incorporates various applications such as an information application 43. The information application 43 is, for instance, a map application, a calendar application, or a browser. The information application 43 is configured to, when executed by the CPU 11, cause the PC 1 to display various types of information on the display 13a in response to user requests. The information application 43 may be an example of an “application program” according to aspects of the present disclosure. The information application 43 itself may not necessarily have a function to print the displayed information.

The general-purpose print program 41 is an OS-standard program provided with the OS 21 and has a function to cause the printer 2 to print information that is displayed on the display 13a by the information application 43. The general-purpose print program 41 in the illustrative embodiment is a program having a function for generating intermediate data based on image data to be printed. The general-purpose print program 41 supports functions that are usable in common by a plurality of printer models provided by vendor(s) of various printers. Unlike printer drivers that are specific to individual printers, the general-purpose print program 41 does not support all of the functions that are unique to the individual printers. Functions supportable by the general-purpose print program 41 are limited to generic functions.

The auxiliary programs 42 include one program or a group of programs configured to, when executed by the CPU 11, cause the PC 1 to perform processing based on instructions from the OS 21, accompanying processing by the general-purpose print program 41. The auxiliary programs 42 include one or more programs that support control of target hardware elements. The auxiliary programs 42 in the illustrative embodiment are compatible with a model of the printer 2 connected with the PC 1. The auxiliary programs 42 are launched from the general-purpose print program 41, for instance, when the PC 1 has received an instruction to cause the printer 2 to perform printing using the general-purpose print program 41. The auxiliary programs 42 are called, for instance, PSA (“PSA” is an abbreviation for “Print Support Application”) or HSA (“HAS” is an abbreviation for “Hardware Support Application”).

For instance, the auxiliary programs 42 may include a combination of a plurality of programs each of which is configured to, when executed by the CPU 11, cause the PC 1 to accept execution instructions. In another instance, the auxiliary programs 42 may include one program configured to, when executed by the CPU 11, cause the PC 1 to accept instructions and perform respective different processes according to the accepted instructions. The auxiliary programs 42 may include a program prepared for each type of printer by the printer vendor(s). For instance, the auxiliary programs 42 may include an auxiliary program prepared for inkjet printers and an auxiliary program prepared for laser printers. The auxiliary programs 42 may include not only the auxiliary program prepared for each type of printer but also an auxiliary program prepared for each model of printer or an auxiliary program prepared for each series of models of printers.

For instance, when a new printer is connected with the PC 1, the OS 21 may cause the PC 1 to download an appropriate auxiliary program from a server or another source depending on a type of the connected printer and to incorporate the downloaded auxiliary program into the PC 1. Then, the OS 21 may cause the PC 1 to store identification information of the incorporated auxiliary program in the memory 12 in association with printer information of the newly connected printer.

As shown in FIG. 1, the PC 1 in the first illustrative embodiment is connected with the cloud server 6 via the Internet 8. The cloud server 6 is an information processing device having a communication function. The virtual printer 5 of the cloud server 6 is configured to, as one of the printers, receive and store a print job from the PC 1, and send the stored print job to a real printer in response to receiving a request to send the print job from the real printer.

When a real printer is connected with the PC 1, the OS 21 registers printer information regarding the real printer. For instance, when a new virtual printer is connected with the PC 1, the OS 21 may register the new virtual printer as one of the printers connectable with the PC1, as well as real printers.

Each of the printers 2 and 3 is a real printer having at least a printing function and a communication function. Each of the printers 2 and 3 is configured to receive print data and print settings from external devices and perform printing in accordance with the received print settings. The printer 2 is not connected with the cloud server 6. The printer 3 is communicably connected with the cloud server 6. For instance, the printer 3, when connected with the cloud server 6, receives from the virtual printer 5 a print job sent to the virtual printer 5, and performs printing based on the received print job.

The auxiliary programs 42 are registered in the general-purpose print program 41 or the OS 21, as programs to be activated in response to the selection of the virtual printer 5, when installed into the PC 1. Common capability information 45 is incorporated in the auxiliary programs 42.

Instead of being incorporated in the auxiliary programs 42, the common capability information 45 may be downloaded from a printer manufacturer's server and stored in the memory 12, by the auxiliary programs 42. In another instance, the common capability information 45 may be downloaded from the virtual printer 5 and stored in the memory 12. In this case, the virtual printer 5 may, in response to a request from the auxiliary programs 42, obtain capabilities of the currently connected real printer, generate the common capability information 45 with respect to commonly executable capabilities, based on the obtained capabilities, and send the generated common capability information 45 to the auxiliary programs 42 as a response to the request.

The common capability information 45 indicates common capabilities of printers connectable with the cloud server 6. In the common capability information 45, extended data 45b based on extended capabilities not supported by the general-purpose print program 41 is written as well as basic data 45a in which print settings based on basic capabilities supported by the general-purpose print program 41.

The extended data 45b includes print settings based on common extended capabilities among the extended capabilities of printers of models or types with which the auxiliary programs 42 are compatible. The common capability information 45 may include print settings that are configurable for printers manufactured by different manufacturers, as long as those printers are connectable with the cloud server 6.

Suppose for instance that, for the item “Sheet Type,” “Plain Paper” and “Envelope” are settable in the basic capability, “Glossy Paper” is settable in the extended capabilities of the printer 3, “Glossy Paper” and “Cloth” are settable in the extended capabilities of the printer 2, and “Glossy Paper” is settable in the extended capabilities of another real printer of a different model. In this case, the common capability information 45 includes “Plain Paper” and “Envelope” as part of the basic data 45a, and “Glossy Paper” as part of the extended data 45b. On the other hand, “Cloth” is capability information specific to the printer 2 and is not included in the common capability information 45.

The extended data 45b further includes print settings for processing that is executable not on the printer side but by the auxiliary programs 42. Examples of the print settings for processing executable by the auxiliary programs 42 may include, but are not limited to, print settings based on image processing such as layout printing, booklet printing, poster printing, watermarking, and saving printing. Examples of the print settings for processing executable by the auxiliary programs 42 may further include print settings that the auxiliary programs 42 are enabled to associate with the print job, such as a PIN setting for setting PIN information used for authority authentication. Even print settings for processing that is not executable on the printer side may be included in the extended data 45b if the relevant printers (i.e., the printers connectable with the cloud server 6) are enabled to operate while ignoring those settings. For instance, if the relevant printers do not have a stapling function and are enabled to discharge sheets while ignoring a setting for “Staple,” the setting for “Staple” may be included in the extended data 45b.

Setting data 46 is stored in the memory 12 of the PC 1. The setting data 46 indicates a setting value as an initial value set for each of the setting items written in the common capability information 45. In the first illustrative embodiment, the setting data 46 is stored in the memory 12 by the auxiliary programs 42. However, the setting data 46 may be stored in the memory 12 by program(s) other than the auxiliary programs 42. The setting data 46 may be a text file or a file in a defined format such as json, csv, or xml. The setting data 46 may be prepared by a printer vendor or a system administrator to customize the operation of the printers, or by an individual user to improve convenience in using the printers.

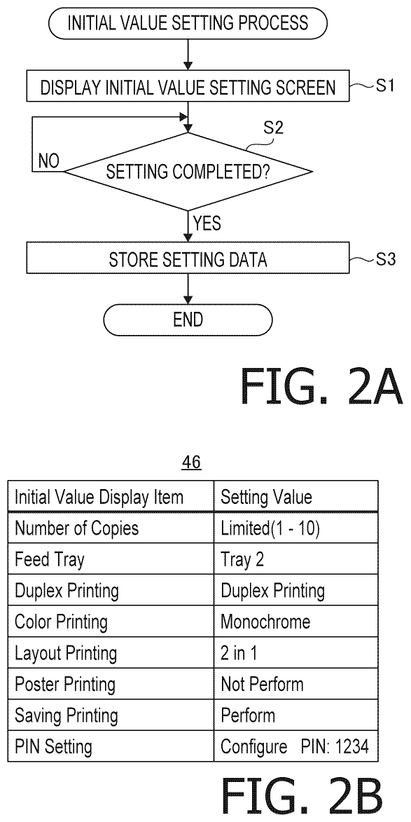

Next, an explanation will be given of a procedure of an initial value setting process to store the setting data 46 in the memory 12 with reference to a flowchart shown in FIG. 2A. Here, the explanation is given under an assumption that the auxiliary programs 42 compatible with the printer 2 perform the initial value setting process shown in FIG. 2A.

Each processing step in the processes, the flowcharts, and the sequence diagrams in the illustrative embodiments according aspects of the present disclosure basically indicates processing by the CPU 11 according to the instructions described in the auxiliary programs 42 and other programs. The processing by the CPU 11 includes hardware control using an API (“API” is an abbreviation for “Application Programming Interface”) of the OS 21. In the present disclosure, the operations by the individual programs may be described without a detailed explanation of the OS 21. In addition, “obtaining” and “acquiring” may be used as concepts that do not necessarily require a request.

For instance, in response to receiving an instruction to set initial values via a utility screen displayed by the auxiliary programs 42, the CPU 11 (more specifically, the CPU 11 executing the auxiliary programs 42) displays an initial value setting screen on the display 13a (S1). The initial value setting screen is configured to accept input of setting values to be written into the setting data 46.

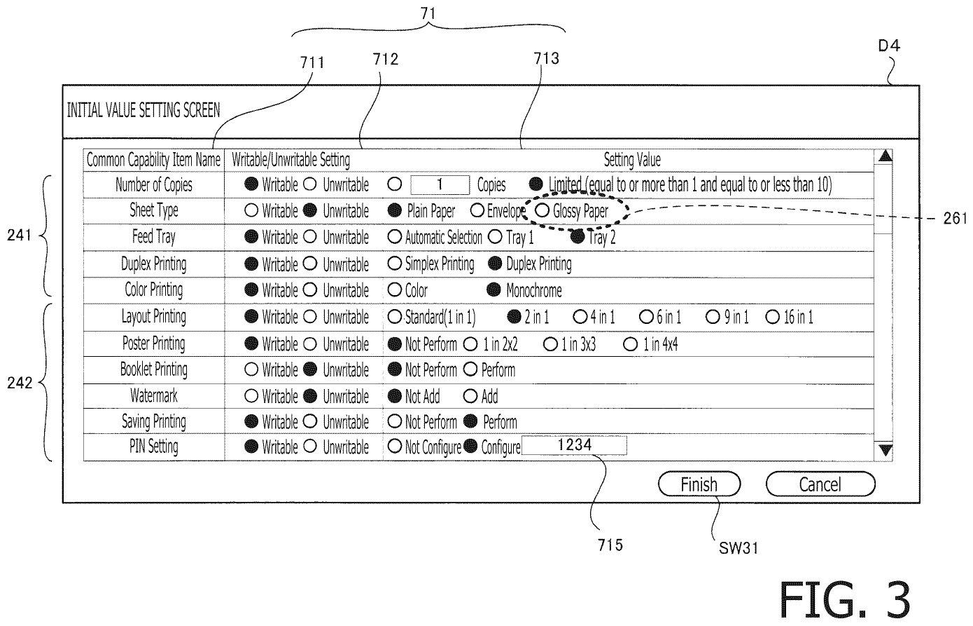

FIG. 3 shows an example of an initial value setting screen D4. The initial value setting screen D4 has an initial value setting area 71 and a finish button SW31. The initial value setting area 71 is an area for setting an initial value for each print setting item. The finish button SW31 is an operable object configured to accept a finish instruction to complete the entry of setting values.

The initial value setting area 71 has an item name display field 711, a writable/unwritable setting field 712, and a setting value input field 713. The item name display field 711 is configured to display an item name of each print setting item written in the common capability information 45. For instance, as indicated by a reference numeral 241 in FIG. 3, in the item name display field 711, the item name of each setting item based on the basic data 45a is displayed. Further, as indicated by a reference numeral 242 in FIG. 3, in the item name display field 711, the item name of each setting item based on the extended data 45b is displayed.

The writable/unwritable setting field 712 is configured to accept a setting of whether to allow a setting value for each setting item to be written onto the general-purpose print setting screen as an initial value. Specifically, the writable/unwritable setting field 712 is configured to accept one of “Writable” to allow the setting value for each setting item to be written as an initial value and “Unwritable” to not allow the setting value for each setting item to be written as an initial value.

The setting value input field 713 is for setting, for each setting item, a setting value to be written as an initial value. In the setting value input field 713, settable parameters written for each item in the common capability information 45 are displayed. Each parameter has a check box for selecting whether to set each parameter as an initial value for a corresponding setting item. In the setting value input field 713, one or more parameters based on the extended data 45b of the printer 2 as indicated by a reference numeral 261 in FIG. 3 may be displayed as well as the parameters based on the basic data 45a.

Referring back to FIG. 2A, the CPU 11 determines whether the setting of the initial values has been completed (S2). For instance, when the finish button SW31 has not been operated, and the completion instruction has not been accepted, the CPU 11 determines that the setting of the initial values has not been completed (S2: No) and continues to accept the setting of the initial values.

For instance, when the finish button SW31 has been operated, and the completion instruction has been accepted (S2: Yes), the CPU 11 stores the contents entered via the initial value setting screen D4 in the memory 12 as the setting data 46 (S3). Thereafter, the CPU 11 terminates the initial value setting process. For instance, as shown in FIG. 2B, the CPU 11 generates the setting data 46 by associating respective setting values selected in the setting value input field 713 with the setting items for which “Writable” is set in the writable/unwritable setting field 712, and stores the generated setting data 46 in the memory 12.

For instance, to promote the saving of colorants and sheets, in FIG. 3, “Writable” is set in the writable/unwritable setting field 712 for each of the items “Number of Copies,” “Duplex Printing,” “Color Printing,” “Layout Printing,” and “Saving Printing.” Then, “Range Limited (equal to or more than 1 and equal to or less than 10)” is set for the item “Number of Copies.” In addition, “Duplex Printing” as a parameter is set for the item “Duplex Printing.” Further, “Monochrome” is set for the item “Color Printing.” Further, “2 in 1” is set for the item “Layout Printing.” Furthermore, “Perform” is set for the item “Saving Printing.” As shown in FIG. 2B, the CPU 11 stores these settings in the memory 12 as the setting data 46. Namely, the CPU 11 generates the setting data 46 listing the setting values to be displayed as initial values, and stores the generated setting data 46 in the memory 12.

In the first illustrative embodiment, for instance, a path of the setting data 46 that indicates a storage location may be previously determined by the auxiliary programs 42. In another instance, a path specified as a storage location for the setting data 46 may be registered in the auxiliary programs 42. In the first illustrative embodiment, for instance, as shown in FIG. 2B, nothing may be written in the setting data 46 for item(s) for which no setting value is to be written into the setting data 46. In another instance, information indicating that no setting value is written in the setting data 46 may be written in the setting data 46.

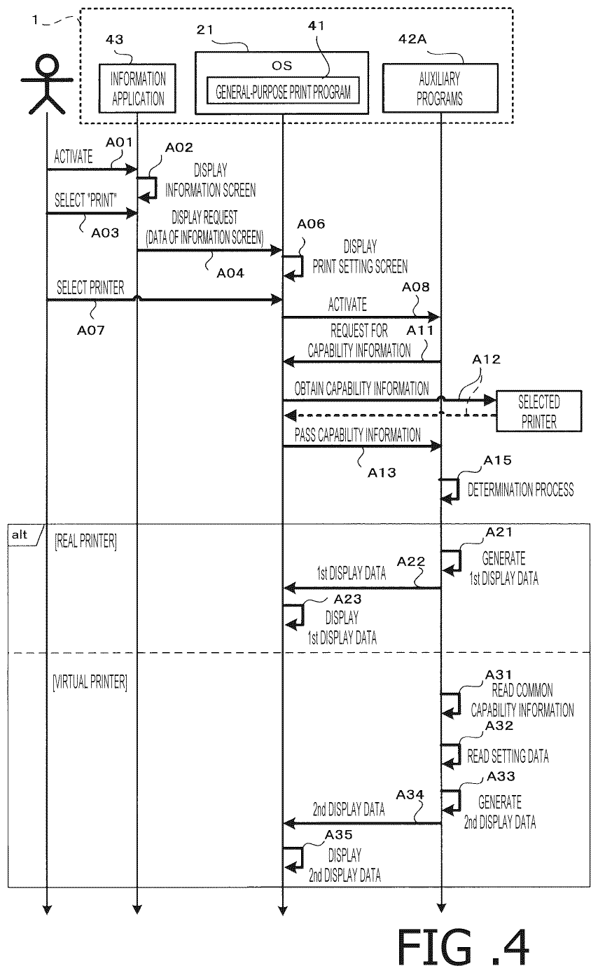

Next, referring to a sequence diagram shown in FIG. 4, an explanation will be given of a procedure for printing that includes operations by the auxiliary programs 42 in the first illustrative embodiment, which is a procedure of processing by the individual programs when “Print” is selected via the information application 43. It is noted that FIG. 4 and after-mentioned other sequence diagrams show operations when the auxiliary programs 42 compatible with the printer 2 is incorporated in the PC 1.

At the beginning of the procedure, a user activates the information application 43 (A01). The information application 43 displays an information screen containing various types of information on the display 13a in response to a user's instruction (A02). If the user wishes to print an image of the information screen being displayed, the user selects “Print” on the information screen (A03). The information application 43 sends a display request along with data of the information screen to the general-purpose print program 41 in the OS 21 (A04).

The general-purpose print program 41 displays a general-purpose print setting screen on the display 13a in response to the display request (A06). The general-purpose print setting screen is configured to accept instructions for print settings and a print execution instruction.

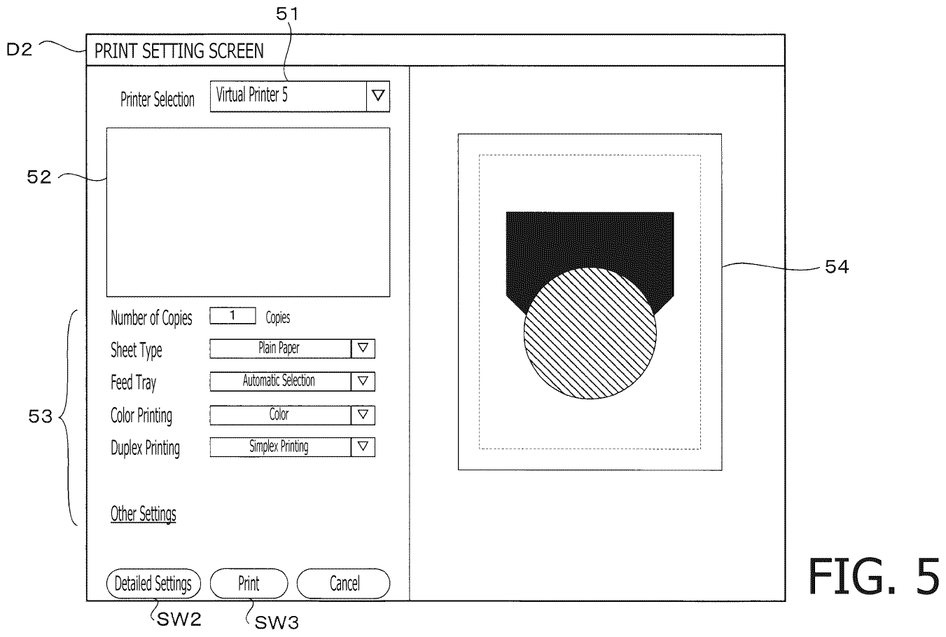

For instance, as shown in FIG. 5, the general-purpose print setting screen D2 includes a printer selection field 51, a notification field 52, a print setting field 53, a preview field 54, a detailed setting button SW2, and a print button SW3. The printer selection field 51 is configured to accept selection of a printer. The notification field 52 is configured to display a notification image. The print setting field 53 is configured to accept designations of various print settings. The preview field 54 is configured to display a preview of an image (i.e., a print target image) of the information screen. The detailed setting button SW2 is configured to accept instructions for detailed print settings. The print button SW3 is configured to accept a print execution instruction.

Printers registered in the OS 21 are selectably displayed in the printer selection field 51. For instance, when the printer 2 and the virtual printer 5 are registered in the OS 21, the printer 2 and the virtual printer 5 are selectably displayed in the printer selection field 51.

The print setting field 53 is configured to display a corresponding print setting item for each function supported by the general-purpose print program 41, and to accept a setting value for the print setting item. Examples of print setting items configurable via the print setting field 53 may include, but are not limited to, “Number of Copies,” “Print Orientation,” “Duplex Printing,” “Sheet Size,” “Feed Tray,” “Print Range,” “Sheet Type,” “Color,” “Borderless Printing,” “Scaling,” and “Print Quality (Resolution).” The print setting field 53 may be configured to display only major items to make it easier to configure the print settings, and to additionally display other items when “Other Settings” is operated.

The notification image displayed in the notification field 52 is an image indicating information to be notified to the user. Examples of the notification image may include, but are not limited to, text, a still image, a video, and a combination of at least two selected therefrom.

As shown in FIG. 4, the user is allowed to select a printer by performing an operation on the printer selection field 51 on the general-purpose print setting screen D2 being displayed (A07). For instance, when the printer 2 or the virtual printer 5 is selected, the general-purpose print program 41 activates the auxiliary programs 42 and sends to the auxiliary programs 42 a processing request for processing according to the selection of the printer 2 (A08). In A08, the general-purpose print program 41 passes information on the selected printer 2 and information on the print settings as set at the time of printer selection to the auxiliary programs 42.

When the printer 2 is set as a normally-used printer in the OS 21, for instance, as shown in FIG. 5, the general-purpose print program 41 displays the general-purpose print setting screen D2 with the printer 2 selected (A06) and activates the auxiliary programs 42 (A08). Namely, the printer 2 is automatically selected by the OS 21, and the general-purpose print program 41 executes A08 based on the information on the selected printer 2. In this case, the user operation in A07 is unnecessary. The same applies when the virtual printer 5 is set as the normally-used printer.

Instead of the general-purpose print program 41 displaying the general-purpose print setting screen D2, the information application 43 may be configured to display the general-purpose print setting screen D2. In such a case, the information application 43 may activate the general-purpose print program 41 in response to “Print” being selected in A03, obtain data to be displayed on the print setting screen D2 from the general-purpose print program 41, and display the print setting screen D2 on the display 13a. Then, the information application 43 may pass the information on the selected printer to the general-purpose print program 41 in response to the printer 2 or the virtual printer 5 having already been selected, or in response to the printer 2 or the virtual printer 5 being selected in A07. Thereby, the general-purpose print program 41 activates the auxiliary programs 42 in A08.

The auxiliary programs 42, in response to being activated, send a request for capability information of the selected printer to the OS 21 (A11). For instance, when the printer 2 is selected in A07, in response to the request from the auxiliary programs 42, the OS 21 sends an obtainment request for the capability information to the printer 2, and obtains the capability information from the printer 2 (A12). The OS 21 passes the capability information obtained from the printer 2 to the auxiliary programs 42 (A13).

For instance, the OS 21 performs communication according to IPP (“IPP” is an abbreviation for “Internet Printing Protocol”) with the printer 2. Instead of sending the request to the OS 21, for instance, the auxiliary programs 42 may directly obtain the capability information from the printer 2 using MIB (“MIB” is an abbreviation for “Management Information Base”).

The capability information obtained from the printer 2 that is a real printer includes information on parameters that are settable as print settings. The capability information further includes, for instance, status information, information on remaining amounts of consumables, information on attached trays, sheet information on sheets set for each tray, and information on supported print resolutions. The printer 2 may have functions to perform image processing based on a received print job and perform printing based on data obtained after the image processing, e.g., functions to perform aggregate printing such as layout printing (N in 1), composition printing such as printing an image combined with a watermark, and saving printing to save colorants. If the printer 2 has image processing functions executable thereon, the printer 2 may pass information on the image processing functions to the OS 21 as capability information.

The capability information obtained from the printer 2 may include information on functions that are not processed by the printer 2 but are processed by the auxiliary programs 42. Examples of the functions that are not processed by the printer 2 but are processed by the auxiliary programs 42 may include, but are not limited to, booklet printing and poster printing.

Further, the capability information obtained from the printer 2 includes specific information to identify the printer 2. Examples of the specific information may include, but are not limited to, device identification information to identify a device. Examples of the device identification information may include, but are not limited to, a hardware key specific to a printer, and information that a printer manufactured by a particular printer manufacturer would have.

On the other hand, the capability information obtained from the virtual printer 5 also contains specific information. However, the specific information obtained from the virtual printer 5 does not include device identification information. The specific information obtained from the virtual printer 5 may include identification information for the virtual printer 5.

In the first illustrative embodiment, the timing and the method to obtain the specific information are the same as those to obtain the capability information. However, the timing and the method to obtain the specific information may be different from those to obtain the capability information. For instance, the auxiliary programs 42 may obtain the specific information from the printer 2 and store the obtained specific information in the memory 12, when searching for devices during the installation of the auxiliary programs 42. For instance, the auxiliary programs 42 may obtain one of the specific information and the capability information directly from the selected printer 2.

After obtaining the capability information, the auxiliary programs 42 perform a determination process (A15). The determination process is a process to determine whether the printer selected on the general-purpose print setting screen D2 is the virtual printer 5, based on the capability information obtained from the general-purpose print program 41 in A08.

For instance, when the specific information received from the general-purpose print program 41 in A08 includes device identification information, the auxiliary programs 42 determine that the selected printer is a real printer (alt: Real Printer). In other words, the auxiliary programs 42 determine that the selected printer is not the virtual printer 5. In this case, the auxiliary programs 42 generate first display data using the capability information of the printer 2 obtained through A11 to A13 (A21). The first display data is for additionally displaying, on the general-purpose print setting screen D2, contents of the setting items in the print settings reflecting the capability information obtained from the selected printer 2.

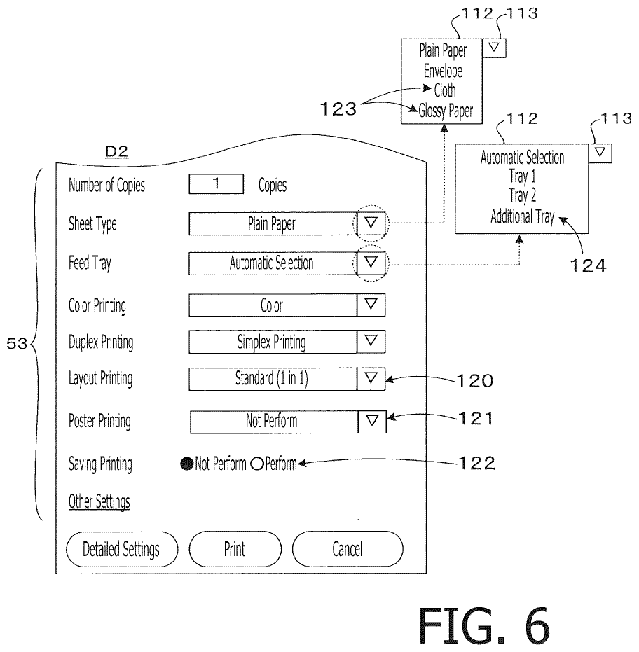

The auxiliary programs 42 pass the generated first display data to the general-purpose print program 41 (A22). The general-purpose print program 41 displays on the display 13a the general-purpose print setting screen D2 as shown in FIG. 6 according to the first display data received from the auxiliary programs 42 (A23).

Suppose for instance that the capability information obtained from the printer 2 includes, as extended capabilities, information indicating that “Cloth” and “Glossy Paper” are settable for the item “Sheet Type,” that “Additional Tray” is settable for the item “Feed Tray,” and that “Layout Printing,” “Poster Printing,” and “Saving Printing” are configurable.

In this case, the general-purpose print setting screen D2 shown in FIG. 6 displays additional print settings based on the extended capabilities, compared to the general-purpose print setting screen D2 based on the general-purpose print program 41 as shown in FIG. 5. Specifically, for instance, the general-purpose print setting screen D2 shown in FIG. 6 additionally displays the items “Layout Printing,” “Poster Printing,” and “Saving Printing,” as indicated by arrows 120, 121 and 122 in FIG. 6. Further, in response to a list button 113 for “Sheet Type” being operated, the general-purpose print setting screen D2 shown in FIG. 6 additionally displays the settable parameters “Cloth” and “Glossy Paper” in a list box 112 for “Sheet Type,” as indicated by arrows 123 in FIG. 6. Further, in response to a list button 113 for “Feed Tray” being operated, the general-purpose print setting screen D2 shown in FIG. 6 additionally displays the settable parameter “Additional Tray” in a list box 112 for “Feed Tray,” as indicated by an arrow 124.

In contrast to the above, as shown in FIG. 4, for instance, when the specific information included in the capability information of the printer 2 as obtained in A13 does not include device identification information and/or includes identification information for the virtual printer 5, the auxiliary programs 42 determines that the selected printer is the virtual printer 5 (alt: Virtual Printer). In this case, the auxiliary programs 42 read the common capability information 45 and the setting data 46 from the memory 12 (A31, A32). The auxiliary programs 42 generate second display data using the read common capability information 45 and the read setting data 46 (A33). The second display data is for displaying contents of the print setting items based on the common capability information 45 on the general-purpose print setting screen D2.

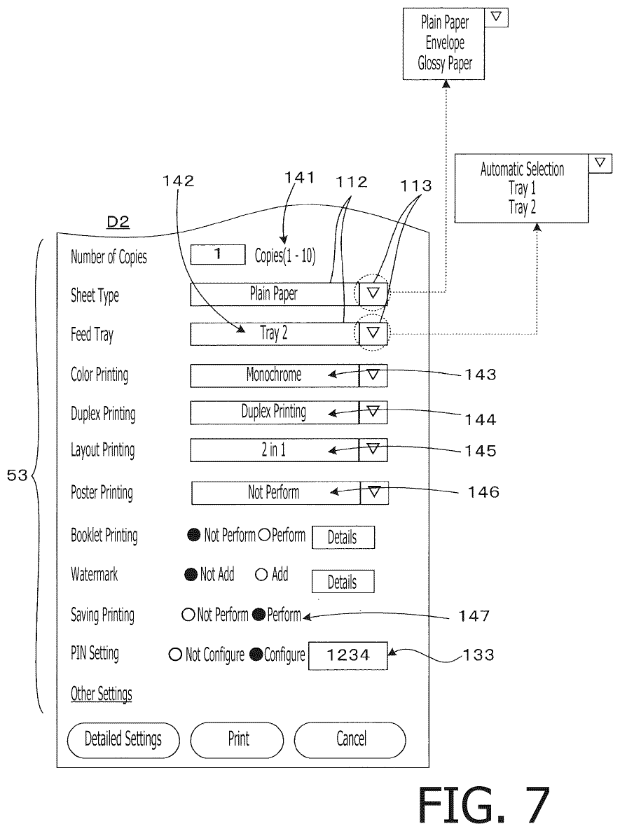

The auxiliary programs 42 pass the generated second display data to the general-purpose print program 41 (A34). The general-purpose print program 41 displays on the display 13a the general-purpose print setting screen D2 as shown in FIG. 7, according to the received second display data (A35).

Suppose for instance that the extended data 45b of the common capability information 45 includes information indicating that “Glossy Paper” is settable for the item “Sheet Type” and that print settings are configurable for “Layout Printing,” “Poster Printing,” “Booklet Printing,” “Watermark,” “Saving Printing,” and “PIN Setting.”

In this case, the general-purpose print setting screen D2 shown in FIG. 7 displays additional items “Layout Printing,” “Poster Printing,” “Booklet Printing,” “Watermark,” “Saving Printing,” and “PIN Setting,” compared to the general-purpose print setting screen D2 based on the general-purpose print program 41 as shown in FIG. 5. Further, the general-purpose print setting screen D2 shown in FIG. 7 additionally displays “Glossy Paper” in the list box 112 for “Sheet Type,” compared to the general-purpose print setting screen D2 based on the general-purpose print program 41 as shown in FIG. 5.

The general-purpose print setting screen D2 shown in FIG. 7 displays contents of the print settings based on the extended data 45b in the common capability information 45 that is not supported by the general-purpose print program 41. Therefore, the general-purpose print setting screen D2 shown in FIG. 7 is enabled to accept not only print settings based on the capabilities of the printer 2 but also print settings based on extended capabilities of printer(s) connected with the cloud server 6.

In addition, the general-purpose print setting screen D2 shown in FIG. 7 displays an initial value for each item based on, for instance, the setting data 46 shown in FIG. 2B. For instance, on the general-purpose print setting screen D2 shown in FIG. 5 or FIG. 6, there is no limitation on the settable values for “Number of Copies.” Further, on the general-purpose print setting screen D2 shown in FIG. 5 or FIG. 6, “Automatic Selection,” “Color,” “Simplex Printing,” and “Standard (1 in 1)” are displayed as initial values for the items “Feed Tray,” “Color Printing,” “Duplex Printing,” and “Layout Printing,” respectively. In contrast, on the general-purpose print setting screen D2 shown in FIG. 7, based on the setting data 46 shown in FIG. 2B, the settable values for “Number of Copies” are limited to a range of “1 to 10” as indicated by an arrow 141 in FIG. 7. In addition, as indicated by arrows 142, 143, and 144 in FIG. 7, “Tray 2,” “Monochrome,” and “Duplex Printing” are displayed as initial values for the items “Feed Tray,” “Color Printing,” and “Duplex Printing,” respectively. Further, for the extended capabilities of “Layout Printing,” “Poster Printing,” “Saving Printing,” and “PIN Setting,” initial values based on the setting data 46 are set as indicated by arrows 145, 146, 147, and 133 in FIG. 7. For “PIN Setting,” the PIN information entered in the PIN information setting field 715 on the initial value setting screen D4 shown in FIG. 3 is displayed.

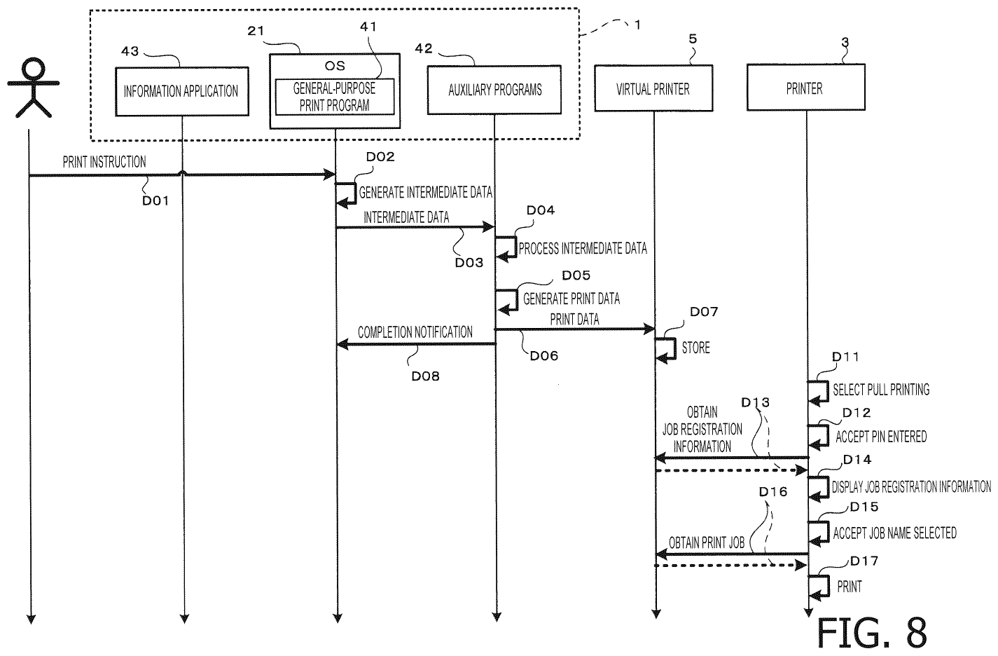

Next, an explanation will be given of procedures by the individual programs when a print execution instruction input by a user operation to the print button SW3 has been received while the general-purpose print setting screen D2 is being displayed, with reference to a sequence diagram in FIG. 8. The print execution instruction may be input by the user directly to the general-purpose print program 41, or may be input to the information application 43 and output from the information application 43 to the general-purpose print program 41. It is noted that, in the present disclosure, the print execution instruction may be referred to as the “print instruction.” FIG. 8 shows a procedure in a case where the print button SW3 is operated on the general-purpose print setting screen D2 (see FIG. 7) which is displayed when the virtual printer 5 is selected.

In response to receiving the user instruction to execute printing via the general-purpose print setting screen D2 shown in FIG. 7 (D01), the general-purpose print program 41 generates intermediate data by converting a format of image data representing a target image to be printed into a format of intermediate data using the print settings accepted on the general-purpose print setting screen D2 (D02), and then passes the generated intermediate data to the auxiliary programs 42 (D03). The information application 43 includes various types of image data. The general-purpose print program 41 converts the image data to be printed into intermediate data suitable for generating print data. If the image data to be printed is suitable for generating print data, generating the intermediate data may be omitted. In this case, the image data to be printed may be used as intermediate data. The intermediate data is, for instance, XPS data.

The auxiliary programs 42 reflect the print settings configured in the auxiliary programs 42 in the intermediate data received in D03, and thus process the intermediate data (D04). For instance, the auxiliary programs 42 combine a watermark with the target image to be printed on the intermediate data when the print settings configured in the auxiliary programs 42 includes a print setting to add the watermark.

The auxiliary programs 42 rasterize the processed intermediate data to generate print data representing the target image to be printed (D05). The print data generated in D05 is, for instance, PDL data that is compatible with the virtual printer 5.

The auxiliary programs 42 send the print data generated in D05 to the virtual printer 5 together with a print command to instruct the execution of printing (D06). At this time, if the auxiliary programs 42 have accepted settings for PIN information and/or for performing saving printing via the general-purpose print setting screen D2 shown in FIG. 7, the auxiliary programs 42 add the accepted settings to the print data. If there is image processing determined to be performed by the virtual printer 5, the auxiliary programs 42 generate the print command including information on the image processing. The auxiliary programs 42 may further provide to the general-purpose print program 41 a completion notification that the transmission of the print data has been completed (D08).

After receiving the print data and the print command, the virtual printer 5 stores and accumulates a print job including the received print data and print command (D07). In this case, the virtual printer 5 stores the print job in association with the PIN information added to the print data.

In response to accepting selection of a pull printing function to receive a print job from the cloud server 6 and perform printing based on the print job (D11), the printer 3 displays a PIN input screen and accepts PIN information entered via the PIN input screen (D12). After accepting the PIN information, the printer 3 obtains job registration information from the virtual printer 5 (D13). For instance, the job registration information includes a list of job names of print jobs stored in the virtual printer 5, and does not include print data or print settings. In the job registration information, each job name is associated with PIN information associated with a corresponding print job.

The printer 3 extracts one or more job names corresponding to the PIN information accepted in D12 from the obtained job registration information and displays the extracted job names (D14). For instance, in response to accepting a job name selected by a touch operation (D15), the printer 3 receives and obtains a print job corresponding to the selected job name from the virtual printer 5 (D16). The printer 3 then performs printing based on the obtained print job (D17). For instance, if the print job includes print data including a watermark and print settings for performing saving printing, a printed material with the watermark added is generated with a reduced amount of colorants used. In the first illustrative embodiment, in D13, the printer 3 has received all the job names of the print jobs stored in the cloud server 6 as the job registration information. In another instance, in contrast, the printer 3 may send a transmission request for the job registration information to the cloud server 6 with PIN information added, and may obtain and display a list of job names associated with the PIN information from the cloud server 6 as the job registration information.

For instance, in response to receiving a print instruction via the general-purpose print setting screen D2 shown in FIG. 6 with the printer 2, which is a real printer, selected (A08), the auxiliary programs 42 execute processes of D02 to D05 in substantially the same manner as when the virtual printer 5 is selected, and send print data and a print command to the printer 2 (D06). In this case, the auxiliary programs 42 generate print data in a format usable for printing by the printer 2. For instance, the auxiliary programs 42 generate PDL data dedicated to the printer 2. In response to receiving the print command and the print data in D06, the printer 2 performs printing.

When the processed intermediate data is rasterized by the auxiliary programs 42 compatible with the printer 2, the rasterization is achieved with a higher degree of freedom and it is more likely that print data suitable for printing by the printer 2 is generated than when rasterized by the general-purpose print program 41. The print data generated by the auxiliary programs 42 may be in a format usable for printing by printers other than the model of the printer 2.

Instead of the auxiliary programs 42 generating the print data, the general-purpose print program 41 may generate the print data. For instance, the auxiliary programs 42 may pass the intermediate data processed in D04 and information on printing to be executed to the general-purpose print program 41. Then, the general-purpose print program 41 may rasterize the processed intermediate data to generate the print data. In this case, the general-purpose print program 41 may pass the generated print data to the auxiliary programs 42. In response to receiving the print data from the general-purpose print program 41, the auxiliary programs 42 send the received print data to the virtual printer 5 or the printer 2 together with the print command for instructing the printer to perform printing.

The print data generated by the general-purpose print program 41 is print data (e.g., PWG Raster data or PDF data) in a format usable for printing by various types of printers. If rasterization is performed by the general-purpose print program 41, it results in a smaller amount of processing by the auxiliary programs 42, thereby avoiding an increase in processing time, and reducing a program size of the auxiliary programs 42.

The general-purpose print program 41 may send the print data and the print command to the virtual printer 5 or the printer 2. Namely, the auxiliary programs 42 may pass the generated print data to the general-purpose print program 41, to be sent from the PC 1 with the virtual printer 5 or the printer 2 as a destination. In such a case, the general-purpose print program 41 may send the print data received from the auxiliary programs 42 to the virtual printer 5 or the printer 2.

As described above, when the virtual printer 5 is selected, the auxiliary programs 42 in the first illustrative embodiment perform processing for displaying the general-purpose print setting screen D2 (see FIG. 7) based on the common capabilities of the printers connectable with the cloud server 6. Thereby, even when virtual printer 5 is selected, the PC 1 executing the auxiliary programs 42 is enabled to handle settings based on the common capability information 45 (including the extended data 45b) without having to prepare separate services to handle settings based on functions specific to individual printers. As a result, the auxiliary programs 42 are enabled to take advantage of the capabilities of printers that are not limited to particular models of printers but include various models of printers connectable with the virtual printer 5.

Further, in response to the selection of a printer in A07 of FIG. 4, the auxiliary programs 42 in the first illustrative embodiment cause the PC 1 to display the general-purpose print setting screen D2 shown in FIG. 7 on the display 13a via the general-purpose print program 41 when the selected printer is the virtual printer 5. This allows the PC 1 to immediately accept input of print settings that match the common capability information 45 of the real printer(s) connected with the virtual printer 5.

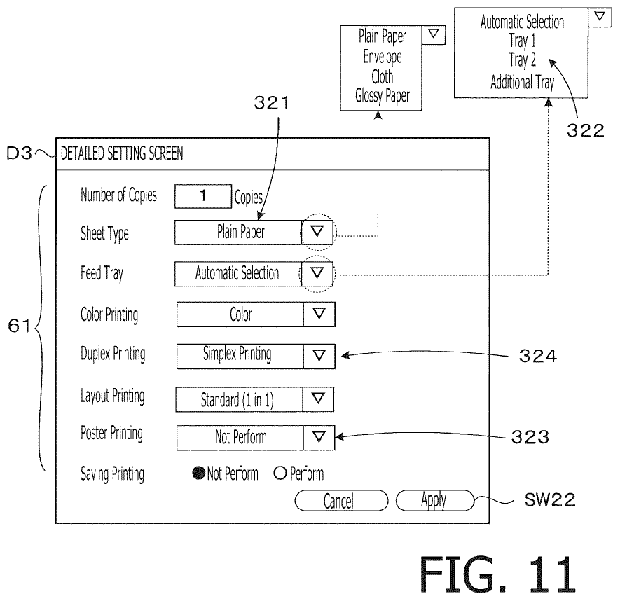

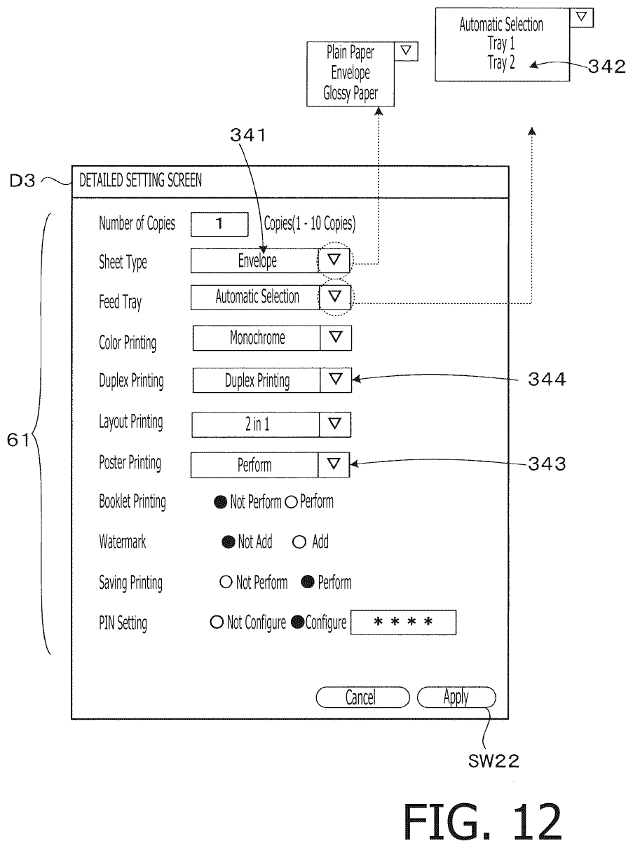

Further, the auxiliary programs 42 in the first illustrative embodiment provide the initial value setting screen D4 for writing setting values into the setting data 46 as initial values. This allows a printer vendor, a system administrator, and an individual user to easily edit the initial values for the print settings according to their purposes. In the first illustrative embodiment, the initial value setting screen D4 is prepared as a dedicated screen. However, the initial value setting screen D4 may be provided as a part of an after-mentioned detailed setting screen D3 (see FIGS. 11 and 12). For instance, an icon for instructing the initial value setting screen D4 to be displayed may be provided on the after-mentioned detailed setting screen D3 (see FIGS. 11 and 12). In this case, the auxiliary programs 42 may cause the PC 1 to display the initial value setting screen D4 in response to an operation to the icon. In another instance, the auxiliary programs 42 may be configured to accept a writable/unwritable setting for each item displayed on the after-mentioned detailed setting screen D3 (see FIGS. 11 and 12). On the other hand, when the initial value setting screen D4 is provided as a separate dedicated screen from the detailed setting screen D3, the auxiliary programs 42 are enabled to activate the initial value setting screen D4 at any timing, thereby allowing the printer vendor, the system administrator, and the individual user to edit the initial values for the print settings.

### Second Illustrative Embodiment

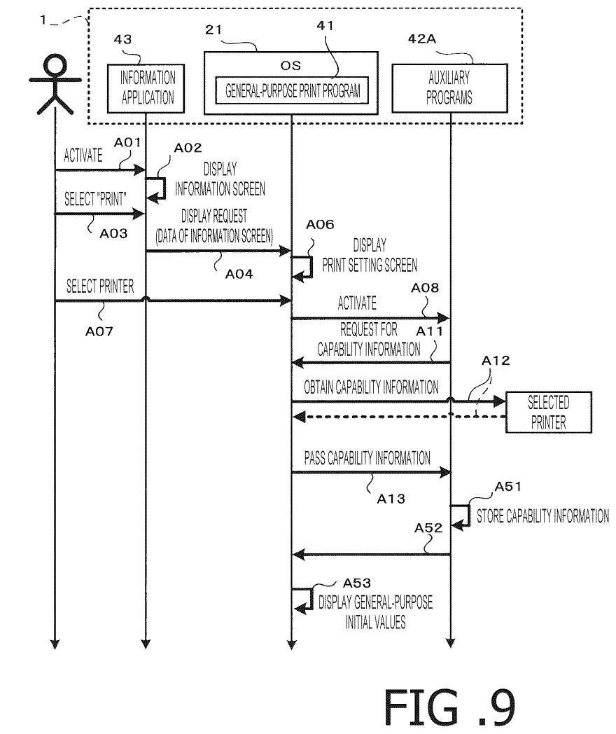

Subsequently, a second illustrative embodiment according to aspects of the present disclosure is described. FIG. 9 is a sequence diagram showing an example of a procedure when “Print” is selected. The second illustrative embodiment differs from the aforementioned first illustrative embodiment in that a detailed setting screen reflecting the common capability information 45 is displayed on the display 13a when the virtual printer 5 is selected. An explanation focusing on the differences between the second illustrative embodiment and the first illustrative embodiment is provided below. In the second illustrative embodiment, with respect to substantially the same or common configurations, processes, and elements as in the first illustrative embodiment, the same reference characters are given thereto, and detailed explanations thereof may be omitted as appropriate.

As shown in FIG. 9, for instance, when the general-purpose print program 41 activates the auxiliary programs 42A with the virtual printer 5 selected on the general-purpose print setting screen D2 shown in FIG. 5 (A07 and A08), the auxiliary programs 42A obtain capability information from the virtual printer 5 (A11 to A13). The auxiliary programs 42A store the capability information obtained from the virtual printer 5 in the memory 12 (A51). The capability information stored in A51 includes, for example, information indicating an appropriate combination of print settings.

When the auxiliary programs 42A have responded to the general-purpose print program 41 (A52), the general-purpose print program 41 displays general-purpose initial values for the general-purpose print program 41 on the general-purpose print setting screen D2 (A53). As shown in FIG. 5, the general-purpose print setting screen D2 is configured to accept instructions for detailed settings via the detailed setting button SW2.

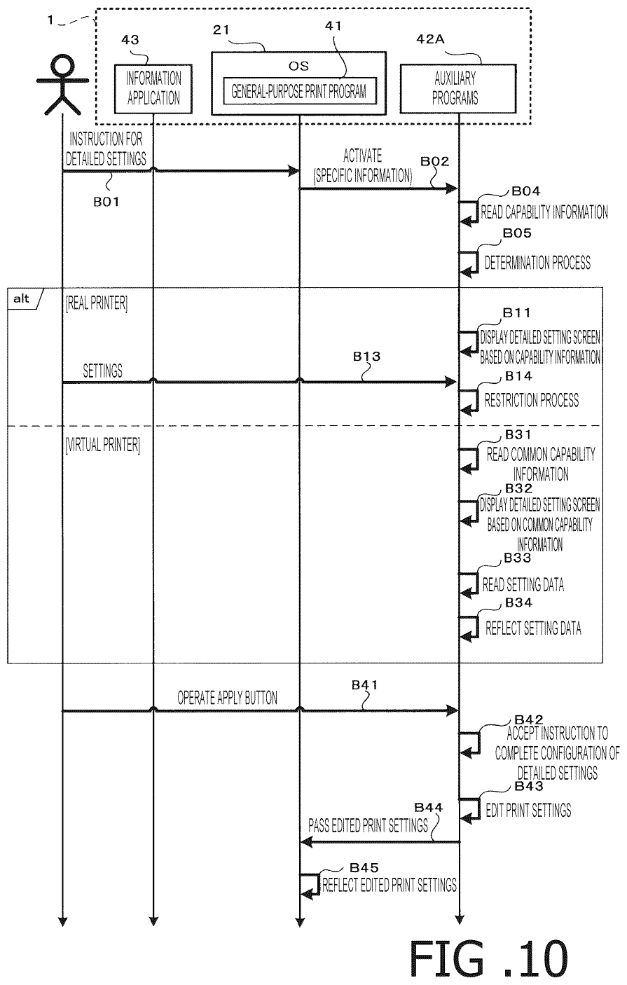

As shown in a sequence diagram in FIG. 10, the general-purpose print program 41 activates the auxiliary programs 42A (B02) in response to a user instruction for detailed settings (B01). The general-purpose print program 41 passes the print settings configured in the print setting field 53 on the general-purpose print setting screen D2 in FIG. 4 to the auxiliary programs 42A, and makes a processing request.

The auxiliary programs 42A read the capability information from the memory 12 (B04) and perform a determination process (B05). The determination process in B05 is performed in substantially the same manner as in A15 of FIG. 4. In response to determining that the selected printer is the virtual printer 5 (alt: Virtual Printer), the auxiliary programs 42A read the common capability information 45 from the memory 12 (B31), and display on the display 13a the detailed setting screen D3 (see FIG. 12) based on the read common capability information 45 (B32). The detailed setting screen D3 shown in FIG. 12 reflects the common capability information 45 in substantially the same manner as the general-purpose print setting screen D2 shown in FIG. 7. Therefore, a specific explanation of how the common capability information 45 is reflected in the detailed setting screen D3 may be omitted.

Furthermore, the auxiliary programs 42A read the setting data 46 from the memory 12 (B33), and reflect the read setting data 46 in the detailed setting screen D3 shown in FIG. 12 (B34). The setting data 46 is reflected in the detailed setting screen D3 in substantially the same manner as in the general-purpose print setting screen D2 shown in FIG. 7. Therefore, a specific explanation of how the setting data 46 is reflected in the detailed setting screen D3 may be omitted.

In response to an apply button SW22 in FIG. 12 being operated (B41), the auxiliary programs 42A accept an instruction to complete the configuration of the detailed settings (B42). The auxiliary programs 42A reflect the detailed print settings accepted via the detailed setting screen D3 in the print settings that have been received from the general-purpose print program 41 in B02, thereby editing the print settings (B43). The auxiliary programs 42A pass the edited print settings to the general-purpose print program 41 (B44). The general-purpose print program 41 reflects the edited print settings in the general-purpose print setting screen D2 shown in FIG. 4 (B45).

The auxiliary programs 42A may read only the extended data 45b of the common capability information 45 from the memory 12 in B31, and may display the detailed setting screen D3 based only on the read extended data 45b in B33. In this case, the contents of the print settings based on the basic capability that overlap with the print settings on the general print setting screen D2 may not be displayed on the detailed setting screen D3. Thus, in this case, the detailed setting screen D3 is rendered easier to view. On the other hand, as described above, when the auxiliary programs 42A display the detailed setting screen D3 based on the common capability information 45 on the display 13a, it is convenient that the user is allowed to configure the print settings based on the basic data 45a and the extended data 45b on the single detailed setting screen D3.

On the other hand, as shown in FIG. 9, when activated with the general-purpose print program 41 selecting the printer 2 on the general-purpose print setting screen D2 (A07, A08), the auxiliary programs 42A obtain the capability information from the printer 2 (A11 to A13), and store the obtained capability information in the memory 12 (A51). Since the processes in A52 and A53 have been described above, an explanation thereof may be omitted.

As shown in the sequence diagram in FIG. 10, in response to receiving the processing request from the general-purpose print program 41 with the printer 2 selected (B01, B02), the auxiliary programs 42A read the capability information corresponding to the printer 2 from the memory 12 (B04), and perform the determination processing (B05). In response to determining that the selected printer is not the virtual printer 5 but a real printer (alt: Real Printer), the auxiliary programs 42A display the detailed setting screen D3 (see FIG. 11) based on the capability information of the printer 2 on the display 13a (B11). The detailed setting screen D3 shown in FIG. 11 reflects the capability information of the printer 2 in substantially the same manner as the general-purpose print setting screen D2 shown in FIG. 6. Therefore, a specific explanation of how the capability information of the printer 2 is reflected in the detailed setting screen D3 may be omitted. It is noted that FIG. 11 shows the detailed setting screen D3 in a state where an after-mentioned restriction process is not performed.

The auxiliary programs 42A accept a parameter set for each item via the user I/F 13 (B13). In the second illustrative embodiment, as described above, the capability information obtained from the printer 2 includes information indicating an appropriate combination of print settings. When the virtual printer 5 is not selected, and the detailed setting screen D3 shown in FIG. 11 that reflects the capability information is displayed, the auxiliary programs 42A are enabled to restrict the acceptance of print settings based on the information indicating the appropriate combination of print settings (B14 in FIG. 10).

Suppose for instance that the printer 2 has a tray 1 and a tray 2 and is configured to feed envelopes from the tray 1 but not from the tray 2. In this case, when “Envelope” is set for the item “Sheet Type” indicated by an arrow 321 on the detailed setting screen D3 shown in FIG. 11, the auxiliary programs 42A do not display “Tray 2” indicated by an arrow 322 in FIG. 11 as a settable parameter for the item “Feed Tray” in such a manner as not to accept a setting of the parameter “Tray 2” for the item “Feed Tray.”

Substantially the same restriction as above may be applied to print settings that the auxiliary programs 42 are enabled to process. For instance, poster printing is a printing method in which a target image to be printed is divided and printed on sheets. Therefore, when “Perform” is set for the item “Poster Printing” indicated by an arrow 323 on the detailed setting screen D3 shown in FIG. 11, the auxiliary programs 42A display only “Simplex Printing” for the item “Duplex Printing” indicated by an arrow 324 in FIG. 11 in such a manner as not to accept a setting of the parameter “Duplex Printing” for the item “Duplex Printing.” Examples of the manner in which the auxiliary programs 42A restrict the acceptance of print settings may include, but are not limited to, graying out as well as hiding (i.e., not displaying).

On the other hand, the auxiliary programs 42A do not perform the restriction process (see B14 in FIG. 10) on the detailed setting screen D3 (see FIG. 12) that is displayed when the virtual printer 5 is selected. Namely, even when “Envelope” is set for “Sheet Type” as indicated by an arrow 341 in FIG. 12, “Tray 2” is displayed as a settable parameter for the item “Feed Tray” as indicated by an arrow 342 in FIG. 12. Further, even when “Perform” is set for “Poster Printing” as indicated by an arrow 343 in FIG. 12, “Duplex Printing” is displayed as a settable parameter for the item “Duplex Printing” as indicated by an arrow 344 in FIG. 12.

As described above, the auxiliary programs 42A in the second illustrative embodiment perform processing to display the detailed setting screen D3 (see FIG. 12) based on the common capabilities of the printers connectable with the cloud server 6, when the virtual printer 5 is selected. Thereby, even when the virtual printer 5 is selected, the PC 1 executing the auxiliary programs 42A is enabled to handle settings based on the common capability information 45 (including the extended data 45b) without having to prepare separate services to handle settings based on functions specific to individual printers.

Further, the auxiliary programs 42A in the second illustrative embodiment cause the PC 1 to display on the display 13a the detailed setting screen D3 (see FIG. 12) based on the common capability information 45, in response to acceptance of an instruction to display the detailed setting screen D3 when the detailed setting button SW2 on the general-purpose print setting screen D2 has been operated. Therefore, the user is allowed to cause the PC 1 to display on the display 13a the detailed setting screen D3 (see FIG. 12) based on the common capability information 45 at the timing when the user wishes to handle settings based on the common capability information 45.

While aspects of the present disclosure have been described in conjunction with various example structures outlined above and illustrated in the drawings, various alternatives, modifications, variations, improvements, and/or substantial equivalents, whether known or that may be presently unforeseen, may become apparent to those having at least ordinary skill in the art. Accordingly, the example embodiment(s), as set forth above, are intended to be illustrative of the technical concepts according to aspects of the present disclosure, and not limiting the technical concepts. Various changes may be made without departing from the spirit and scope of the technical concepts according to aspects of the present disclosure. Therefore, the disclosure is intended to embrace all known or later developed alternatives, modifications, variations, improvements, and/or substantial equivalents. Some specific examples of potential alternatives, modifications, or variations according to aspects of the present disclosure are provided below.

For instance, devices and apparatuses connected with the PC 1 are not limited to printers, but may be any devices (e.g., multi-function peripherals, copiers, and fax machines) having a printing function. The number of printers connected with the PC 1 is not limited to the example (i.e., one) shown in the relevant drawings, but may be two or more.

The general-purpose print setting screen D2 shown in FIG. 5 may be configured to accept a display instruction to display the detailed setting screen D3 in response to an operation to an object such as a link instead of the detailed setting button SW2.

The restriction process in B14 in FIG. 10 may be omitted. However, when the printer 2, which is a real printer, is selected, it is possible to suppress the occurrence of errors in the printer 2 by restricting the acceptance of unconfigurable print settings based on the capability information. On the other hand, when the virtual printer 5 is selected, the auxiliary programs 42A do not perform the restriction process because it is not known which printer will finally be used for printing and it is not possible to determine whether configured print settings are acceptable. Thereby, it is possible to reduce a processing load on the auxiliary programs 42A.

The process of A32 in FIG. 4 may be omitted. In this case, the setting values of the setting data 46 may not be configured as initial values on the general-purpose print setting screen D2 (see FIG. 7) that is displayed when the virtual printer 5 is selected. Further, the processes of B33 and B34 in FIG. 10 may be omitted. In this case, the setting values of the setting data 46 may not be configured as initial values on the detailed setting screen D3 (see FIG. 12) that is displayed when the virtual printer 5 is selected. However, when the virtual printer 5 is selected via the general-purpose print program 41, the setting values of the setting data 46 are configured as initial values on the general-purpose print setting screen D2 or the detailed setting screen D3 in addition to the items and parameters corresponding to the extended data 45b being displayed thereon. This makes it possible to use the virtual printer 5 based on the common setting values.

The selection of whether to write the setting values into the setting data 46 may be made collectively, rather than for each print setting item. For instance, the writable/unwritable setting field 712 shown in FIG. 3 may be omitted. In this case, a single writable/unwritable setting button may be provided on the initial value setting screen D4. However, when the selection of whether to write the individual setting values into the setting data 46 is made for each print setting item, it is possible to distinguish, based on the setting data 46, between items that are used commonly and items that are not used commonly when the virtual printer 5 is selected. Thus, it is possible to achieve a higher degree of freedom in the use of the virtual printer 5.

When the capability information obtained in A13 in FIG. 4 includes an appropriate combination of print settings, the auxiliary programs 42 may include, in the first display data, particular information for not accepting print settings that are not in an appropriate combination in A21, and may pass the first display data including the particular information to the general-purpose print program 41 in A22. Thereby, the general-purpose print programs 41 are enabled to restrict the acceptance of print settings that are not in an appropriate combination, for instance, on the general-purpose print setting screen D2 shown in FIG. 6, in substantially the same manner as on the detailed setting screen D3 shown in FIG. 11. On the other hand, when the virtual printer 5 is selected, the auxiliary programs 42 may not include, in the second display data, particular information for not accepting print settings that are not in an appropriate combination in A33 in FIG. 4, in such a manner that such a restriction is not applied on the general-purpose print setting screen D2 in FIG. 7.

Even if the common capabilities are displayed when the printer selection is made as shown in FIG. 4, the auxiliary programs 42 may perform processing to reflect the common capabilities in the detailed setting screen D3 when the detailed settings are configured as shown in FIG. 10. The cloud server 6 with the virtual printer 5 provided thereon may be connected with a LAN or a WAN.

The cloud server 6 may be a server installed on the Internet 8 by a manufacturer that provides the auxiliary programs 42, or may be a commercial server such as OneDrive (“OneDrive” is a registered trademark of Microsoft Corporation) or Dropbox (“Dropbox” is a registered trademark of Dropbox, Inc.).

In the aforementioned illustrative embodiments, only the printing operation has been described in detail as the operation by the auxiliary programs 42. However, the auxiliary programs 42 may further have other roles. Examples of the program to perform the processing in the aforementioned illustrative embodiments are not limited to the auxiliary programs 42, but may include any program configured to accept instructions from the OS 21 or the general-purpose print program 41 when printing is performed using the general-purpose print program 41. For instance, a print workflow application (Print workflow) whose specifications have been published by Microsoft Corp. may be included in the examples of the program to perform the processing in the aforementioned illustrative embodiments.

Practicable examples of the execution timing for executing the auxiliary programs 42 are not limited to the example in the aforementioned illustrative embodiments. For instance, the auxiliary programs 42 may be executed in response to a direct execution instruction from the OS 21. In another instance, the auxiliary programs 42 may be resident programs. In this case, the auxiliary programs 42 may perform the aforementioned operations in response to receiving execution commands.

In any flowchart disclosed in the aforementioned illustrative embodiments, a plurality of processes in a plurality of any steps may be arbitrarily changed in the execution order thereof or may be executed in parallel as long as there is no inconsistency in the processing results.

The processing disclosed in the aforementioned illustrative embodiments may be performed by one or more CPUs, one or more hardware elements such as ASICs, or a combination of at least two selected therefrom. The processing disclosed in the aforementioned illustrative embodiments may be implemented in various aspects such as a non-transitory computer-readable storage medium storing computer-readable instructions (e.g., programs) for performing the processing, or a method for performing the processing.

The following shows examples of associations between elements illustrated in the aforementioned illustrative embodiment(s) and modification(s), and elements claimed according to aspects of the present disclosure. For instance, the Internet 8 may be an example of a “network” according to aspects of the present disclosure. The cloud server 6 may be an example of a “server” according to aspects of the present disclosure. The PC 1 may be an example of an “information processing device” according to aspects of the present disclosure. The CPU 11 may be an example of a “computer” according to aspects of the present disclosure. The memory 12 may be an example of a “non-transitory computer-readable storage medium” according to aspects of the present disclosure. The display 13a may be an example of a “display” according to aspects of the present disclosure. The auxiliary programs 42 may be an example of “computer-readable instructions” according to aspects of the present disclosure. The general-purpose print program 41 may be an example of a “general-purpose print program” according to aspects of the present disclosure. The information application 43 may be an example of an “application program” according to aspects of the present disclosure. The general-purpose print setting screen D2 shown in FIG. 6 and the detailed setting screen D3 shown in FIG. 11 may be included in examples of a “first print setting screen” according to aspects of the present disclosure. The general-purpose print setting screen D2 shown in FIG. 7 and the detailed setting screen D3 shown in FIG. 12 may be included in examples of a “second print setting screen” according to aspects of the present disclosure.

What is claimed is:

1. A non-transitory computer-readable storage medium storing computer-readable instructions that are executable by a computer of an information processing device, the instructions supporting a general-purpose print program incorporated in advance in an operating system of the information processing device, the instructions being configured to, when executed by the computer, cause the information processing device to:
obtain specific information to identify a selected printing device;
obtain capability information indicating capabilities of the selected printing device;
in response to receiving a processing request from the general-purpose print program, determine whether the selected printing device is a virtual printer based on the obtained specific information, the virtual printer being provided on a server on a network and connectable with the information processing device, the server being configured to receive and store a print job sent to the virtual printer, and to send the stored print job to a printing device connected with the server in response to a request from the printing device; and
perform a display process to display, on a display of the information processing device, different print setting screens depending on whether the selected printing device is the virtual printer, the display process comprising:
a first display process to display a first print setting screen on the display in response to determining that the selected printing device is not the virtual printer, the first print setting screen being configured to accept print settings based on the obtained capability information; and
a second display process to display a second print setting screen on the display in response to determining that the selected printing device is the virtual printer, the second print setting screen being configured to accept print settings based on common capabilities of printing devices connectable with the server.

2. The non-transitory computer-readable storage medium according to claim 1,
wherein the instructions are further configured to, when executed by the computer, cause the information processing device to:
in response to receiving the processing request from the general-purpose print program when a printing device selection is made to specify the selected printing device, determine whether the selected printing device is the virtual printer based on the obtained specific information.

3. The non-transitory computer-readable storage medium according to claim 2,
wherein the general-purpose print program is configured to, when executed by the computer, cause the information processing device to display a general-purpose print setting screen on the display, and
wherein the instructions are further configured to, when executed by the computer, cause the information processing device to:
in response to determining that the selected printing device is not the virtual printer, perform, in the first display process, generating first display data for additionally displaying, on the general-purpose print setting screen, contents of setting items in print settings reflecting the obtained capability information, and passing the generated first display data to the general-purpose print program, thereby causing the general-purpose print setting screen according to the first display data to be displayed as the first print setting screen on the display via the general-purpose print program; and
in response to determining that the selected printing device is the virtual printer, perform, in the second display process, generating second display data for displaying, on the general-purpose print setting screen, contents of setting items in print settings based on the common capabilities, and passing the generated second display data to the general-purpose print program, thereby causing the general-purpose print setting screen according to the second display data to be displayed as the second print setting screen on the display via the general-purpose print program.

4. The non-transitory computer-readable storage medium according to claim 1,
wherein the instructions are further configured to, when executed by the computer, cause the information processing device to:
in response to receiving the processing request from the general-purpose print program when a display instruction to display a detailed setting screen has been received via the general-purpose print program, determine whether the selected printing device is the virtual printer based on the obtained specific information;
in response to determining that the selected printing device is not the virtual printer, perform the first display process to display, as the first print setting screen, the detailed setting screen configured to accept print settings based on the obtained capability information; and
in response to determining that the selected printing device is the virtual printer, perform the second display process to display, as the second print setting screen, the detailed setting screen configured to accept print settings based on the common capabilities.

5. The non-transitory computer-readable storage medium according to claim 4,
wherein the instructions are further configured to, when executed by the computer, cause the information processing device to:
when the detailed setting screen is being displayed to accept print settings based on the obtained capability information through the first display process, restrict acceptance of unconfigurable print settings based on the capability information; and
when the detailed setting screen is being displayed to accept print settings based on the common capabilities through the second display process, not restrict acceptance of print settings via the detailed setting screen.

6. The non-transitory computer-readable storage medium according to claim 1,
wherein the common capabilities include extended capabilities that are not supported by the general-purpose print program.

7. The non-transitory computer-readable storage medium according to claim 6,
wherein the instructions are further configured to, when executed by the computer, cause the information processing device to:
in response to determining that the selected printing device is the virtual printer, perform the second display process comprising:
reading extended data and setting data, the extended data being data in which print settings based on the extended capabilities are written, the setting data being data in which respective setting values for individual print setting items are written; and
displaying, on the display, the second print setting screen configured to accept print settings based on the read extended data, the setting values written in the read setting data being configured as initial values on the second print setting screen.

8. The non-transitory computer-readable storage medium according to claim 7,
wherein the instructions are further configured to, when executed by the computer, cause the information processing device to:
display, on the display, an initial value setting screen configured to accept input of the setting values to be written into the setting data;
store, in a memory of the information processing device, the setting data in which the setting values accepted via the initial value setting screen are written; and
in response to determining that the selected printing device is the virtual printer, perform the second display process comprising:
reading the extended data, and the setting data stored in the memory; and
displaying, on the display, the second print setting screen configured to accept the print settings based on the read extended data, the setting values written in the read setting data being configured as the initial values on the second print setting screen.

9. The non-transitory computer-readable storage medium according to claim 8,
wherein the instructions are further configured to, when executed by the computer, cause the information processing device to:
display, on the display, the initial value setting screen configured to accept, for each print setting item, selection of whether to write a corresponding setting value into the setting data, and input of the corresponding setting value;
write, into the setting data, the corresponding setting value input via the initial value setting screen for each print setting item for which the selection to write the corresponding setting value into the setting data has been accepted via the initial value setting screen, among the print settings.

10. The non-transitory computer-readable storage medium according to claim 1,
wherein the instructions are further configured to, when executed by the computer, cause the information processing device to:
in response to receiving a request for processing from the general-purpose print program when a print instruction to cause the virtual printer to print a target image has been output from an application program incorporated in the information processing device to the general-purpose print program, obtain image data representing the target image from the general-purpose print program, and send a print job with the obtained image data to the virtual printer.

11. A printing system comprising:
a server on a network, the server having a virtual printer;
a printing device connected with the server; and
an information processing device configured to connect with the virtual printer provided on the server on the network, the information processing device comprising:
a computer; and
a non-transitory computer-readable storage medium storing computer-readable instructions supporting a general-purpose print program incorporated in advance in an operating system of the information processing device, the computer-readable instructions being configured to, when executed by the computer, cause the information processing device to, in response to receiving a request for processing from the general-purpose print program when a print instruction to cause the virtual printer to print a target image has been output from an application program incorporated in the information processing device to the general-purpose print program, obtain image data representing the target image from the general-purpose print program, and send a print job with the obtained image data to the virtual printer,
wherein the server is configured to receive and store the print job sent to the virtual printer,
wherein the printing device is configured to send a transmission request to the server to send the print job stored in the server, to receive the print job sent by the server in response to the transmission request, and to perform printing based on the received print job, and
wherein the computer-readable instructions are further configured to, when executed by the computer, cause the information processing device to:
obtain specific information to identify a selected printing device;
obtain capability information indicating capabilities of the selected printing device;
in response to receiving a processing request from the general-purpose print program, determine whether the selected printing device is a virtual printer based on the obtained specific information; and
perform a display process to display, on a display of the information processing device, different print setting screens depending on whether the selected printing device is the virtual printer, the display process comprising:
a first display process to display a first print setting screen on the display in response to determining that the selected printing device is not the virtual printer, the first print setting screen being configured to accept print settings based on the obtained capability information; and
a second display process to display a second print setting screen on the display in response to determining that the selected printing device is the virtual printer, the second print setting screen being configured to accept print settings based on common capabilities of printing devices connectable with the server.

12. A method implementable by a computer executing computer-readable instructions on an information processing device, the instructions supporting a general-purpose print program incorporated in advance in an operating system of the information processing device, the method comprising:
obtaining specific information to identify a selected printing device;
obtaining capability information indicating capabilities of the selected printing device;
determining, in response to receiving a processing request from the general-purpose print program, whether the selected printing device is a virtual printer based on the obtained specific information, the virtual printer being provided on a server on a network and connectable with the information processing device, the server being configured to receive and store a print job sent to the virtual printer and to send the stored print job to a printing device connected with the server in response to a request from the printing device; and
performing a display process to display, on a display of the information processing device, different print setting screens depending on whether the selected printing device is the virtual printer, the display process comprising:
a first display process to display a first print setting screen on the display in response to determining that the selected printing device is not the virtual printer, the first print setting screen being configured to accept print settings based on the obtained capability information; and
a second display process to display a second print setting screen on the display in response to determining that the selected printing device is the virtual printer, the second print setting screen being configured to accept print settings based on common capabilities of printing devices connectable with the server.
